(19) United States
(12) Patent Application Publication
(10) Pub. No.: US 2015/0334332 A1
(43) Pub. Date: Nov. 19, 2015

(54) System and Method for Apparatus Interconnectivity

(71) Applicant: GLOBAL INVACOM LTD, Hertfordshire (GB)

(72) Inventor: Gary Stafford, Hertfordshire (GB)

(73) Assignee: Global InvaCom Ltd., Hertfordshire (GB)

(21) Appl. No.: 14/649,137

(22) PCT Filed: Dec. 3, 2013
(86) PCT No.: PCT/GB2013/053198

§ 371 Date: Jun. 2, 2015

(30) Foreign Application Priority Data
Dec. 3, 2012 (GB) 1221723.8

(51) Int. Cl. H04N 5/38; H04N 5/44; H04B 1/00

(52) U.S. Cl. CPC H04N 5/38; H04B 1/0057; H04N 5/44

(57) ABSTRACT

The invention relates to a system and method for the distribution and processing of data, for video and/or audio and most typically HDMI, IF and/or stored data, via a cable connection system to a plurality of sets of processing apparatus at a location such as a domestic or commercial premises. The method and apparatus allow the distribution of the HDMI data to be achieved in a robust and reliable manner via a plurality of diplexer apparatus.

The invention to which this application relates is apparatus and a method to allow the distribution of data between at least one data receiving location at a premises and a plurality of locations with, at each of the locations, apparatus being provided to allow the data which is received to be processed and used to generate any of a plurality of user selectable services. The invention is particularly, although not necessarily exclusively, provided to allow data received, for example, via satellite or cable transmission systems, and which is subsequently used to generate television and/or radio services, to be distributed to apparatus at different locations in a premises and to allow the data from the different apparatus to be available to be transferred and /or accessed by other apparatus provided in connection therewith.

The ability to receive broadcast data at a receiving location at a premises and then provide that data via a coaxial cable connection to processing apparatus located within the premises, is well known. However, problems exist when there is provided receiving apparatus at a plurality of locations in the premises. Typically at each location a set of apparatus is required with, at each set at least one means for processing data to provide television and/or radio services. Typically when a number of sets of apparatus are provided, the desire is to allow each of the sets of apparatus to be used independently by different users at the same time and to allow the users to select their own particular service or operation of a particular set of apparatus with which they are interacting without interrupting or interfering with the operation of the other sets of apparatus. This can be difficult to achieve generally and is particular problematic when dealing with High Definition Multimedia Interface (HDMI) data connections.

It is known to be able to provide the transmission of HDMI data via a wireless connection but in many instances the use of a wireless connection is impractical, can potentially be unreliable and/or there is a resistance to using wireless transmission systems.

A further problem which is experienced is that now that many of the processing apparatus includes a storage means such as a hard drive it is typically the case that the content of that hard drive can only be viewed or accessed via, for example a display screen and speakers which are connected to that particular processing apparatus in which the hard drive is located and which therefore form a particular set of apparatus. This can be frustrating if it is desired to access the data from the hard drive at another location via another set of apparatus and may also be problematic if, for example the processing apparatus with which the hard drive is located develops another fault which makes the use of the same unattractive.

The aim of the present invention is therefore to provide apparatus to allow the efficient transfer of data, such as HDMI data, between sets of processing apparatus in order to allow that data to be available at each of the sets of processing apparatus. A further aim is to improve the general connectivity between sets of processing apparatus so as to allow access to be gained to data which may be stored in one processing apparatus to be made available to another processing apparatus.

In a first aspect there is provided apparatus for receiving broadcast data and distributing the same to and between at least two sets of processing apparatus, said apparatus including means for receiving the broadcast data, an IF diplexer and a first coaxial cable connection therefrom leading to a first set of processing apparatus which includes a broadcast data receiver, said broadcast data receiver having an output to an HDMI transmitter to transmit data therefrom along the said first coaxial cable to the said IF diplexer and wherein at the said IF diplexer the data transmitted from the first set of processing apparatus is passed via a further coaxial cable connection to at least one second set of processing apparatus including an HDMI receiver and made available for viewing and/or listening.

Typically therefore the HDMI data is made available for output at a plurality of locations at which a set of processing apparatus is provided.

In one embodiment the first and further coaxial cable connections from the IF diplexer provide an IF feed to a broadcast data receiver in each of the sets of processing apparatus.

In one embodiment the IF diplexer is mounted with or provided integrally with the Low Noise Block (LNB) of the receiving apparatus.

In one embodiment each of the sets of processing apparatus includes an IF diplexer to allow the splitting of the IF data feed to the broadcast data receiver of that set of apparatus and the transfer of data between the sets of processing apparatus.

In one embodiment the data which is transferred between the first and further sets of processing apparatus is data which is retrieved from storage media provided in one of the sets of apparatus and made available for processing by a second set of processing apparatus.

Typically the HDMI data is received at at least one of the sets of apparatus from a wireless communication network

Typically the data which is transmitted from the IF diplexer includes IF data stacked along with HDMI data so as to allow the IF and HDMI data to be carried along the common coaxial cable. In one embodiment the said IF data is separated from the HDMI data by a selected frequency band to prevent or minimise interference between the two sets of data.

In a further aspect of the invention there is provided a system for the provision of video and/or audio data and a distribution network for the same, said network including a means for receiving IF data and HDMI data, cables for connecting the said means to at least two sets of processing apparatus, and wherein a first cable is provided along which the stacked IF data and HDMI data is transmitted to a first set of the apparatus and data from the said first set of apparatus is carried in the opposite direction along said first cable to allow the same to be distributed to further sets of processing apparatus.

Typically the first set of apparatus includes a data receiver which allows the processing of the IF data and/or HDMI data to provide a video and/or audio service and also includes an HDMI data transmitter which transmits the HDMI data to a diplexer from which the HDMI data is passed to a second set of apparatus.

Typically the said diplexer outputs IF data to the first cable for the first set of apparatus and IF data via a second cable to the second set of apparatus.

In a further aspect of the invention there is provided a method for receiving broadcast data and distributing the same to and between at least two sets of processing apparatus, said apparatus including means for receiving the broadcast data, an IF diplexer and a first coaxial cable connection therefrom and passing IF and HDMI data along the cable to a first set of processing apparatus which includes a broadcast data receiver to allow the data to be made available for viewing and/or listening, outputting from the broadcast data receiver of the first set of processing apparatus data to an HDMI transmitter at the first set of apparatus to transmit the data therefrom along the said first coaxial cable to the said IF diplexer and wherein at the said IF diplexer the data received from the first set of processing apparatus is passed via a further coaxial cable connection to at least one second set of processing apparatus including an HDMI receiver and made available for viewing and/or listening.

Typically the method includes adding the IF data to the data received from the first set of processing apparatus when transmitting the data to the second set of apparatus so that the IF data is also available to the broadcast data receiver at the second set of processing apparatus.

Specific embodiments of the invention are now described with reference to the accompanying diagrams; wherein

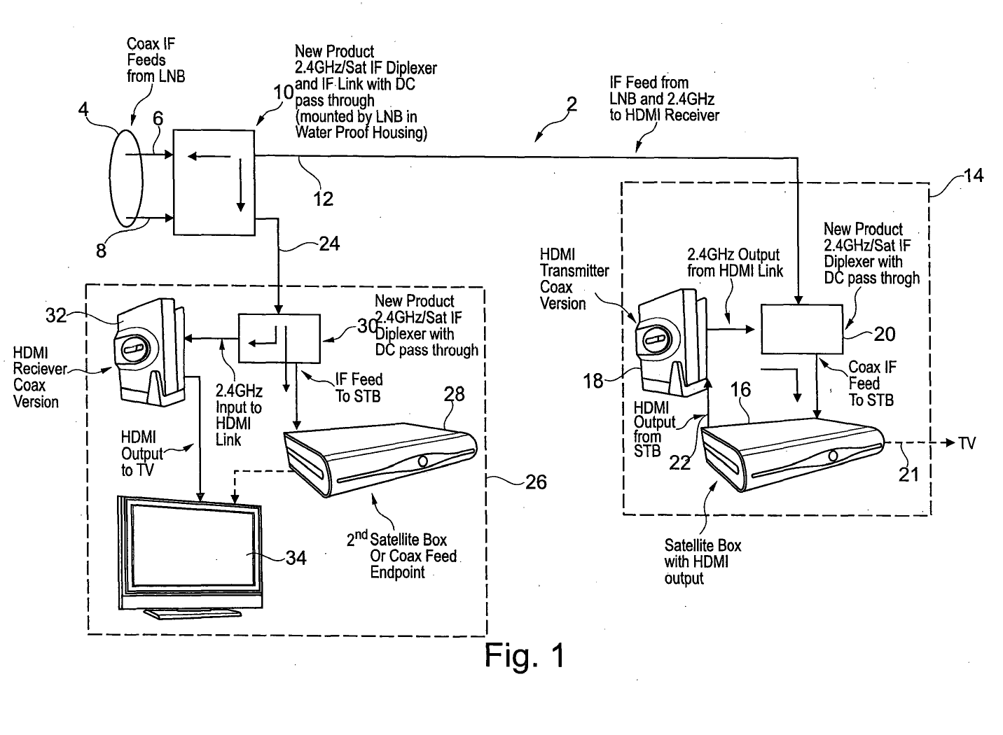

FIG. 1 illustrates in a schematic manner a system in accordance with one embodiment of the invention;

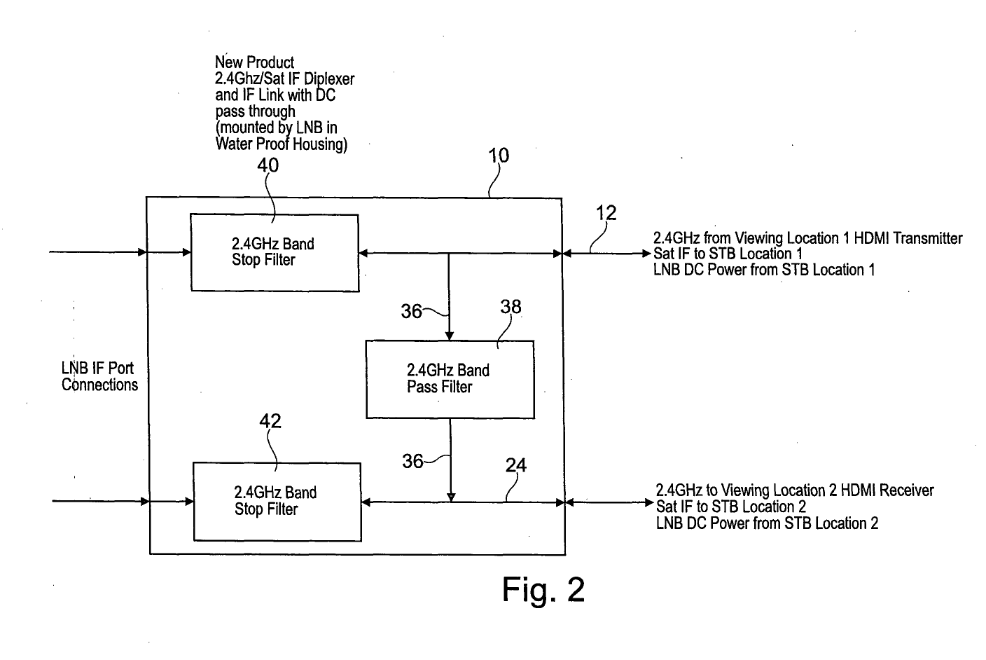

FIG. 2 illustrates the operation of the IF diplexer mounted at the LNB in accordance with one embodiment of the invention; and

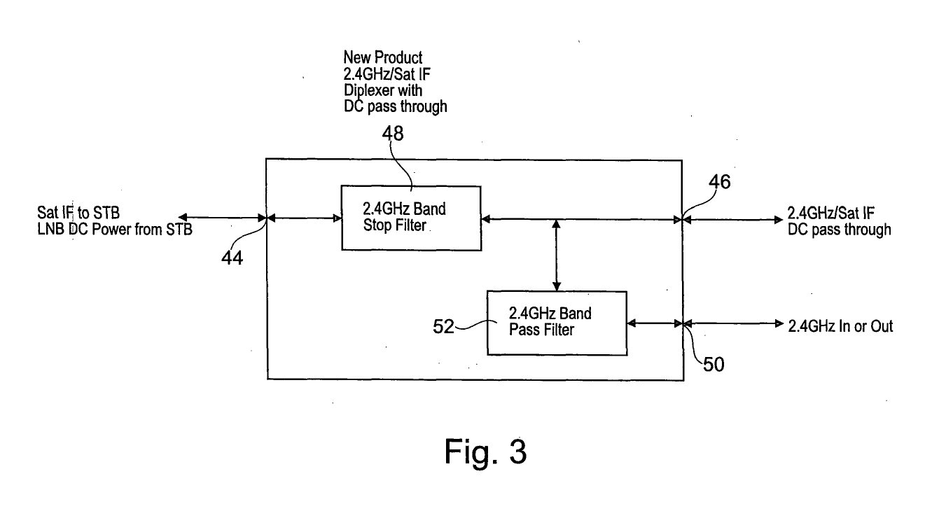

FIG. 3 illustrates the operation of the IF diplexer provided at the set of processing apparatus in accordance with one embodiment of the invention.

Referring firstly to FIG. 1 there is illustrated a system in accordance with one embodiment of the invention. The system is provided within a premises 2 such as a domestic dwelling. The premises is provided (typically on the wall externally of the same) with receiving apparatus 4 including a satellite antenna or a cable connection for receiving broadcast data in the form of video and or audio data, at specified frequency ranges. In this example, the receiving apparatus 4 is provided with first and second data feeds, 6,8 from an LNB (not shown). The data feeds which can include HDMI data, are fed into a diplexer 10, typically for Intermediate Frequency signals. A first coaxial cable connection 12 is connected to an output of the diplexer and leads to a first set of processing apparatus 14 indicated by broken lines. In this embodiment the set of apparatus includes a broadcast data receiver 16 with a data storage means, a transmitter 18 for HDMI data and a diplexer 20. The output from the cable connection 12 at the set of apparatus 14 includes the IF data stacked with HDMI data and all of this data passes through the diplexer 20 to the broadcast data receiver 16. The broadcast data receiver 16 includes an output 21 which allows the passage of the IF data and the HDMI data to a connected display screen (not shown) and/or speakers (not shown). In addition a data output 22 from the broadcast data receiver 16 is provided which passes data to the transmitter 18. This data can be HDMI data and/or data retrieved from the storage means of the broadcast data receiver. The transmitter 18 provides a 2.4 GHz data output which is fed to the diplexer 20. This data is output from the diplexer 20 to pass back along the cable connection 12 to the diplexer 10. The signal back can also include a DC power supply for the operation of the diplexers. Thus the HDMI data from the output of the broadcast data receiver 16 can be transferred to the second set of apparatus 26 without the need for the use of a wireless transmission system and in the manner as now described.

From the diplexer 10, the HDMI data is transferred onto the further coaxial cable connection 24 which connects a second set of processing apparatus 26 to the diplexer 10. In this case the second set of apparatus includes a broadcast data receiver 28, a diplexer 30, HDMI receiver 32 and display screen 34. Thus in accordance with this embodiment, the data which is output from the broadcast data receiver 16 of the first set of apparatus 14 is made available to be used at the second set of processing apparatus. The data from the first broadcast data receiver may be the HDMI data and/or may be data which is already stored in, for example, the hard disc drive provided in the same. At the second set of apparatus, the received HDMI data is transferred from the diplexer 30 to the HDMI receiver 32 and passed to the display screen 34 and speakers (not shown). The IF data is transmitted from the diplexer 30 to the broadcast data receiver 28 of the second set of apparatus for processing and display on the 34 display screen 34 and speakers (not shown).

It should be appreciated that this process can be repeated for third, fourth and further sets of apparatus at the location in the same manner so as to allow the transfer of data between the sets of apparatus in an robust and efficient manner.

As shown in FIG. 2, the IF diplexer 10 allows, via connection 12 the transmission of an IF feed, which can be of a conventional format, to the first set of processing apparatus 14. However in accordance with the invention the diplexer 10 also receives from the first set of processing apparatus the HDMI transmitted data signal, and/or data from the storage means and DC power. The data signal received from the connection 12 passes through the diplexer as indicated by arrow 36 through band pass filter 38 to the cable connection 24 to the second set of apparatus 16 due to the provision of the two 2.4 GHz band stop filters 40,42 which prevents the passage of the data to the other outputs and thereby provide the IF data and the HDMI data to the second set of apparatus 26.

FIG. 3 illustrates the diplexers 20, 30 and show how they allow, at port 44, the output of the IF/HDMI data feed to the broadcast data receiver 16 or 28 and the input of the DC power. The port 46 allows the input of the IF feed and HDMI data and due to the provision of the stop filter 48 and the HDMI data passes through the 2.4 GHz pass filter 52 and can be fed out of the port 50 as is the case with diplexer 20 or received into the port 50 as is the case with diplexer 30 depending on the location of the diplexer.

There is therefore provided a system which allows the transmission of HDMI data within different locations of a premises using cable connections between the sets of apparatus at the different locations and in many instances will be more robust than the use of an equivalent wireless system and allows, in many cases, already existing coaxial cable connections to be utilised.

1. Apparatus for receiving broadcast data and distributing the same to and between at least two sets of processing apparatus, said apparatus including means for receiving the broadcast data, an IF diplexer and a first coaxial cable connection therefrom leading to a first set of processing apparatus which includes a broadcast data receiver, said broadcast data receiver having an output to an HDMI transmitter to transmit data therefrom along the said first coaxial cable to the said IF diplexer and wherein at the said IF diplexer the data transmitted from the first set of processing apparatus is passed via a further coaxial cable connection to at least one second set of processing apparatus including an HDMI receiver and made available for viewing and/or listening.

2. Apparatus according to claim 1 wherein the HDMI data is made available for output at a plurality of sets of apparatus at different locations within a premises.

3. Apparatus according to claim 1 wherein the first and further coaxial cable connection from the IF diplexer provide an IF feed to a broadcast data receiver in each of the sets of processing apparatus.

4. Apparatus according to claim 1 wherein the IF diplexer is mounted with or provided integrally with a Low Noise Block of the receiving apparatus.

5. Apparatus according to claim 1 wherein each of the sets of processing apparatus includes an IF diplexer to allow the splitting of the IF data feed to the broadcast data receiver and the data transferred between the sets of processing apparatus.

6. Apparatus according to claim 1 wherein the data which is transferred between the first and second sets of processing apparatus includes data which is retrieved from storage media provided in the first or second set of processing apparatus to make the same available for processing by the other of the first or second set of processing apparatus.

7. Apparatus according to claim 1 wherein the data which is transmitted from the IF diplexer includes IF data stacked along with HDMI data.

8. Apparatus according to claim 7 wherein the HDMI data and the IF data carried along the common cable.

9. Apparatus according to claim 8 wherein the said IF data is separated from the HDMI data by a frequency band to prevent or minimise interference between the two sets of data.

10. A system for the provision of video and/or audio data and a distribution network for the same, said network including a means for receiving IF data and HDMI data, cables for connecting the said means to at least two sets of processing apparatus, and wherein a first cable is provided along which the stacked IF data and HDMI data is transmitted to a first set of the apparatus and data from the said first set of apparatus is carried in the opposite direction along said first cable to allow the same to be distributed to further sets of processing apparatus.

11. A system according to claim 10 wherein the first set of apparatus includes a data receiver which allows the processing of the IF data and/or HDMI data to provided a video and/or audio service and also includes an HDMI data transmitter which transmits the HDMI data to a diplexer from which the HDMI data is passed to a second set of apparatus.

12. A system according to claim 11 wherein the said diplexer outputs IF data to the first cable for the first set of apparatus and a further cable for the supply of IF data to the second set of apparatus.

13. A method for receiving broadcast data and distributing the same to and between at least two sets of processing apparatus, said apparatus including means for receiving the broadcast data, an IF diplexer and a first coaxial cable connection therefrom and passing IF and HDMI data along the cable to a first set of processing apparatus which includes a broadcast data receiver to allow the data to be made available for viewing and/or listening, outputting from the broadcast data receiver of the first set of processing apparatus data to an HDMI transmitter at the first set of apparatus to transmit the data therefrom along the said first coaxial cable to the said IF diplexer and wherein at the said IF diplexer the data received from the first set of processing apparatus is passed via a further coaxial cable connection to at least one second set of processing apparatus including an HDMI receiver and made available for viewing and/or listening.

14. A method according to claim 13 wherein the method includes adding the IF data to the data received from the first set of processing apparatus when transmitting the data to the second set of apparatus so that the IF data is also available to the broadcast data receiver at the second set of processing apparatus.
